(19) United States
(12) Patent Application Publication
(10) Pub. No.: US 2025/0292382 A1
(43) Pub. Date: Sep. 18, 2025

(54) WELLBORE CLEANING TOOL EVALUATION

(71) Applicant: Schlumberger Technology Corporation, Sugar Land, TX (US)

(72) Inventors: Jason Dickson, Aberdeen (GB); Andrew Gilbert, Aberdeen (GB); James Atkins, Aberdeen (GB); Steven Villareal, Katy, TX (US)

(21) Appl. No.: 19/065,722

(22) Filed: Feb. 27, 2025

Related U.S. Application Data
(60) Provisional application No. 63/564,015, filed on Mar. 12, 2024.

(51) Int. Cl. G06T 7/00; E21B 37/02; E21B 47/002; G06T 7/40; G06T 7/60; G06T 7/90

(52) U.S. Cl. CPC G06T 7/0002; E21B 37/02; E21B 47/002; G06T 7/40; G06T 7/60; G06T 7/90; G06T 2207/20081

(57) ABSTRACT

A method for estimating an effectiveness of a wellbore cleaning operation includes acquiring digital images of selected cutting elements on a borehole cleaning tool before and after a downhole cleaning operation; comparing the digital images acquired after the downhole cleaning operation with the digital images acquired before the downhole cleaning operation to determine a wear or damage to the selected cutting elements caused by the downhole cleaning operation; and estimating an effectiveness of the cleaning operation from the determined wear or damage to the selected cutting elements.

### CROSS REFERENCE TO RELATED APPLICATIONS

The present disclosure claims priority from U.S. Provisional Appl. No. 63/564,015, filed on Mar. 12, 2024, herein incorporated by reference in its entirety.

### BACKGROUND

Cleaning tools are commonly used to clean the internal surface of wellbore casing. Such tools commonly include cleaning elements such as scraping, brushing, and/or milling elements to scour the casing ID. The scouring action of the cleaning elements is intended to remove debris, such as cement and mud cake, from the internal surface of the wellbore casing.

One difficulty with conventional cleaning tools is that there is no way to determine the effectiveness of the cleaning action. While post cleaning inspection operations may be employed, such operations are expensive and time-consuming in that they often require running another tool into the well after the cleaning or drilling operation has been completed. There is a need for an inexpensive method to estimate cleaning effectiveness without borehole reentry.

### SUMMARY

Methods and systems for evaluating the effectiveness of a wellbore cleaning operation are disclosed. In one example embodiment, a method includes acquiring before and after digital images of selected cutting elements on a borehole cleaning tool in which the before images are acquired before a downhole cleaning operation and the after images acquired after the downhole cleaning operation. The before and after digital images are compared to determine wear or damage to the selected cutting elements caused by the downhole cleaning operation. A measure of casing string cleaning effectiveness is estimated from the determined wear or damage, in which the measure of casing string cleaning effectiveness increases with increasing determined wear or damage.

This summary is provided to introduce a selection of concepts that are further described below in the detailed description. This summary is not intended to identify key or essential features of the claimed subject matter, nor is it intended to be used as an aid in limiting the scope of the claimed subject matter.

### BRIEF DESCRIPTION OF THE DRAWINGS

For a more complete understanding of the disclosed subject matter, and advantages thereof, reference is now made to the following description taken in conjunction with the accompanying drawings, in which:

FIG. 1 depicts an example drilling rig including an example cleaning tool;

FIG. 2 depicts an example cleaning tool;

FIGS. 3A and 3B (collectively FIG. 3) depict longitudinal cross sectional views of a portion of the example cleaning tool shown in FIG. 2 with the depicted cleaning element retracted (3A) and extended (3B);

FIG. 4 depicts a flowchart of one example method for evaluating the effectiveness of a wellbore cleaning operation;

FIG. 5 depicts a flow chart of another example method for evaluating the effectiveness of a wellbore cleaning operation;

FIG. 6 depicts an example block diagram of machine learning model training; and

FIG. 7 depicts a block diagram of an example system for estimating the effectiveness of a wellbore cleaning operation.

### DETAILED DESCRIPTION

Embodiments of this disclosure include systems and methods for evaluating the effectiveness of wellbore cleaning operations. One example method for cleaning a section of a downhole casing string includes digital images of selected cutting elements in a cleaning tool before the cleaning operation. The cleaning tool is then deployed in a wellbore and used to clean a section of a downhole casing string. The cleaning tool is then tripped out of the wellbore and digital images of the selected cutting elements are acquired after the cleaning operation. A measure of casing string cleaning effectiveness is estimated by evaluating the first and second digital images using a trained machine learning algorithm. In example embodiments, the trained machine learning algorithm may be configured to estimate geometry related changes (such as size and shape of the selected cutting elements) caused by the cleaning operation and to estimate the measure of casing string cleaning effectiveness from the estimated geometry changes.

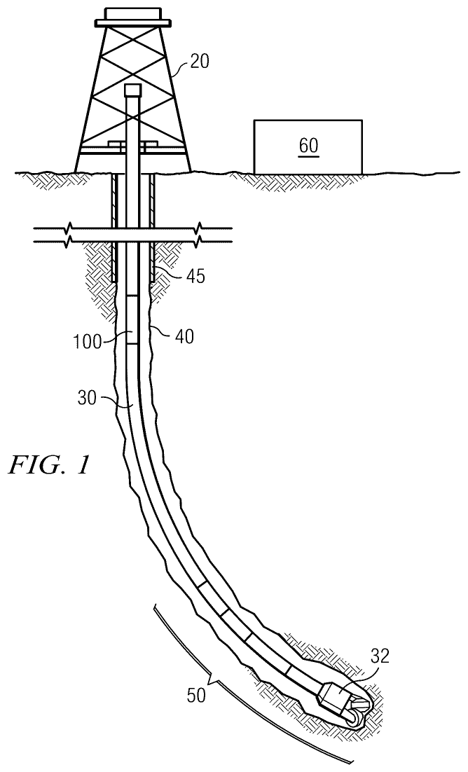

FIG. 1 depicts an example drilling rig 20 including a system 60 for evaluating the effectiveness of a wellbore cleaning operation. The drilling rig 20 may be positioned over a subterranean formation (not shown) and may be configured for drilling a geothermal well or a hydrocarbon exploration and/or production well. The rig 20 may include, for example, a derrick and a hoisting apparatus (also not shown) for raising and lowering a drill string 30, which, as shown, extends into a wellbore 40 through a section of casing string 45. The casing string 45 may include a plurality of casing joints cemented into a section of the wellbore 40 as is well known in the industry. After a cementing operation, residual cement and/or mud cake (drilling fluid particulate) may be adhered to the internal surface of the casing string. Such debris is commonly removed during subsequent wellbore cleaning operations.

The drill string may include a bottom hole assembly 50 (BHA) including, for example, a drill bit 32 and optional steering (such as a rotary steerable), logging while drilling (LWD), and measurement while drilling (MWD) tools. In this type of system, the wellbore 40 may be formed in the subsurface formations by rotary drilling in a manner that is well-known to those of ordinary skill in the art (e.g., via directional drilling techniques). Those of ordinary skill in the art given the benefit of this disclosure will appreciate, however, that the present invention may find application in drilling applications other than conventional rotary drilling (e.g., mud-motor based directional drilling), and is not limited to land-based rigs.

As is known to those of ordinary skill, the drill string 30 may be rotated, for example, at the surface and/or via a downhole deployed mud motor to drill the well. A pump may deliver drilling fluid to the interior of the drill string 30 thereby causing the drilling fluid to flow downwardly through the drill string 30. The drilling fluid exits the drill string 30, e.g., via ports in a drill bit 32, and then circulates upwardly through the annulus region between the outside of the drill string 30 and the wall of the wellbore 40. In this known manner, the drilling fluid lubricates the drill bit 32 and carries formation cuttings up to the surface.

With continued reference to FIG. 1, the drill string may further include a wellbore cleaning tool 100 deployed above the BHA. The wellbore cleaning tool 100 may include substantially any suitable cleaning tool that is configured to scrape or scour an inner surface of the wellbore casing 45 or other downhole tubing. The tool 100 may include, for example, a blowout preventor (BOP) cleaning tool, a casing cleaning tool, or a riser cleaning tool. It will be understood, of course, that the disclosed embodiments are not limited to use with any particular wellbore cleaning tool.

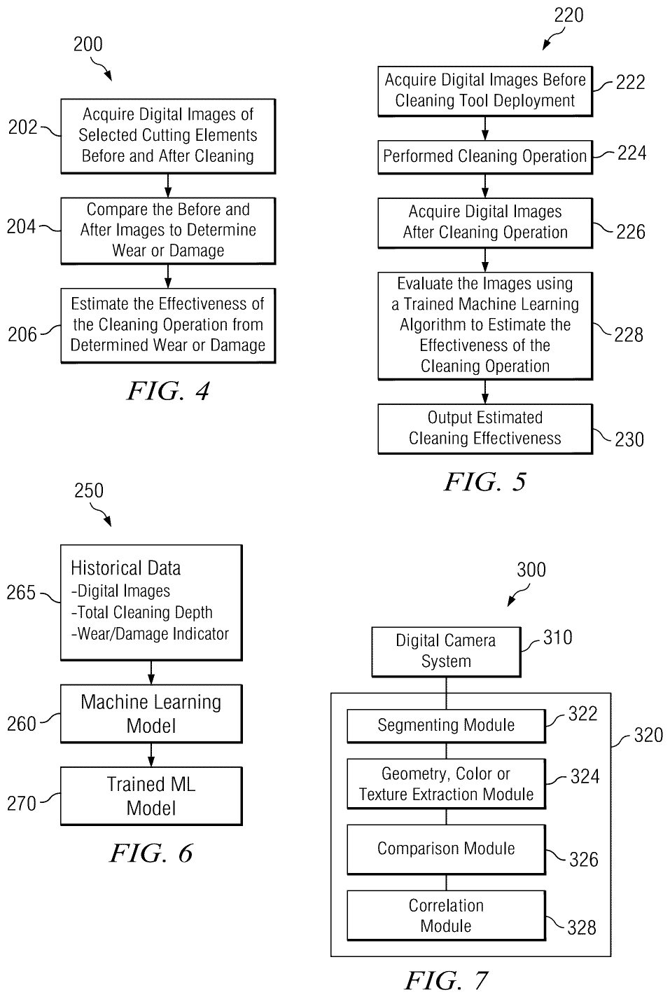

As noted above the rig 20 may include a system 60 configured to take and automatically evaluate digital images of cutting elements employed in the cleaning tool and to estimate the effectiveness of the wellbore cleaning operation. The system 60 may be deployed at the rig site (e.g., in an onsite laboratory as depicted) or offsite. The disclosed embodiments are, of course, not limited in this regard. The system 60 may include computer hardware and software configured to automatically or semi-automatically evaluate the acquired digital images of the cutting elements. To perform these functions, the hardware may include one or more processors (e.g., microprocessors) which may be connected to one or more data storage devices (e.g., hard drives or solid state memory). As is known to those of ordinary skill, the processors may be further connected to a network, e.g., to receive the images from a networked camera system (not shown) or another computer system. The system 60 may be further configured to receive a trained machine learning model. It will be further understood that the disclosed embodiments may include processor executable instructions stored in the data storage device. The executable instructions may be configured, for example, to execute methods 200 and 220 (FIGS. 4 and 5) to evaluate the cleaning operation. It will, of course, be understood that the disclosed embodiments are not limited to the use of or the configuration of any particular computer hardware and/or software. It will be appreciated that the computer hardware and software may be located locally (e.g., at the rig site) and/or remotely (e.g., in the cloud). In example embodiments, the digital images may be taken locally and transmitted to the cloud for further processing.

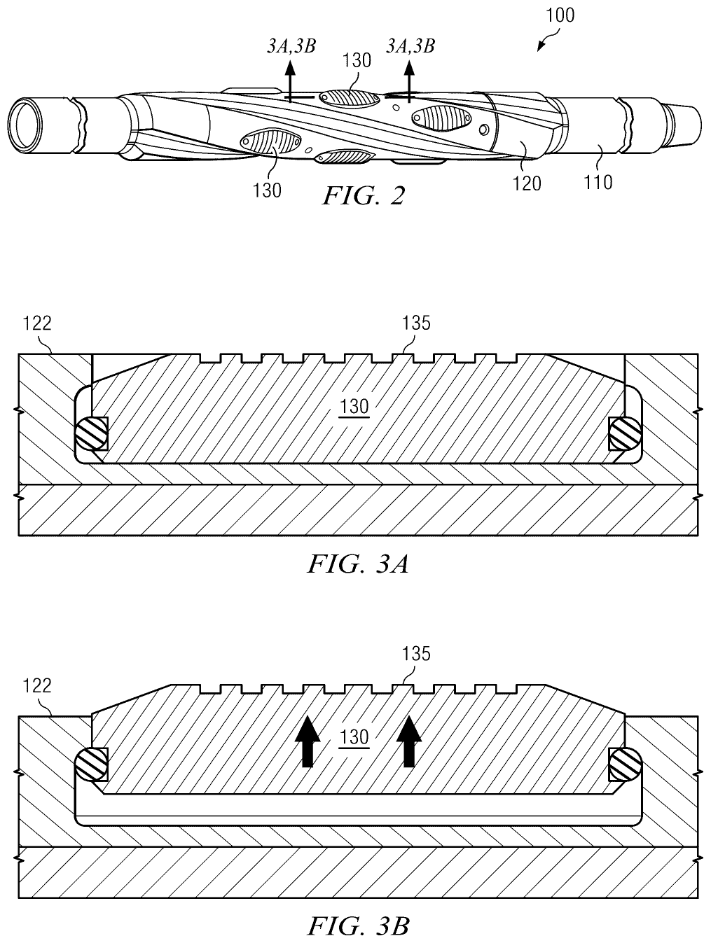

FIG. 2 depicts an example cleaning tool 100 that may be evaluated using system 60. The depicted example cleaning tool 100 includes a tool body 110 (or collar) having threaded ends for coupling with a drill string (e.g., drill string 30 in FIG. 1). The example cleaning tool 100 may further include one or more blades 120 extending radially outward from the tool body 110. Cleaning elements 130 may be deployed in the tool body 110 or in the blades 120 (e.g., as depicted). The cleaning elements may include scraping, brushing, and/or milling elements configured to scrape or scour a casing (or another internal surface in the wellbore). The cleaning tool 100 is configured to rotate with the drill string such that the scouring action of the cleaning elements removes debris from the internal surface of the wellbore casing. While the disclosed embodiments are not limited in this regard, wellbore cleaning operations are commonly conducted while tripping the drill string (and cleaning tool) out of the wellbore and commonly involves reciprocating the tool in the uphole and downhole directions along a section of cased wellbore (e.g. five or ten passes).

Turn now to FIGS. 3A and 3B (collectively FIG. 3), longitudinal cross sectional views of one example cleaning element 130 are depicted. In FIG. 3A, the cleaning element 130 is retracted such that the cleaning element is stowed below or approximately flush with an outer surface 122 of the corresponding blade. During a normal drilling operation, the cleaning elements 130 may be retracted as depicted in FIG. 3A so as not to become damaged or create unnecessary drag. When required for cleaning, for example, after the completion of a drilling operation and while tripping the drill string out of the wellbore, the cleaning elements 130 may be extended, for example as depicted in FIG. 3B. When extended, the scraping, brushing, and/or milling elements may be pressed into contact with the inner surface of the casing or liner.

FIG. 3 further depicts cutting features 135 (such as scraping, brushing, and/or milling elements) in the outer surface of the cleaning element 130. It will be appreciated that these cutting features 135 provide the scraping or scouring action during the cleaning operation. One aspect of the disclosed embodiments was the realization that the cutting features 135 can become worn or damaged during a cleaning operation and that the extent of the wear or damage may be indicative of the effectiveness of the cleaning operation. For example, increased wear or damage may be indicative of more effective cleaning (such as more aggressive scraping of the casing). Another aspect of the disclosed embodiments was the realization that such wear and/or damage may be determined via evaluating digital images taken before and after the cleaning operation. Moreover, it was further realized that such digital images may be evaluated using a trained machine learning (ML) algorithm.

FIG. 4 depicts a flowchart of one example method 200 for evaluating the effectiveness of a wellbore cleaning operation. The method includes acquiring calibrated digital images of selected cutting elements in a cleaning tool before and after the cleaning operation 202. The digital images acquired after the cleaning operation may be compared with those acquired before the cleaning operation at 204 to determine a wear or damage to the selected cutting elements caused by the cleaning operation (i.e., a change in the condition of the cutting elements). The wear or damage may be quantified (or determined) using one or more of several metrics. For example, the wear or damage may be quantified as a quantity of lost material in the cutting features, or by a change in cuttings feature shape (e.g., from sharp and angular to rounded). In such examples, wear or damage may be quantified as a change in the size of the cuttings features or a change in the shape of the cutting features.

With continued reference to FIG. 4, the effectiveness of the cleaning operation may then be estimated at 206 from the determined wear or damage to the selected cutting elements, with more wear or damage indicating improved cleaning and scraping of the inner surface of the casing. Estimating the effectiveness of the cleaning operation may further include, for example, determining a normalized wear or damage parameter based on a total scraping or cleaning distance of the cleaning operation (e.g., 10 passes over a length of 100 m resulting in a total cleaning distance of 1000 m) and estimating a cleaning effectiveness parameter from the normalized wear or damage. In the examples above, the change in the size of the cuttings features or the change in the shape of the cutting features may be normalized, for example, by dividing by the total cleaning distance. The estimated cleaning effectiveness parameter or normalized wear or damage parameter may include, for example, a numerical indicator or categorization (or label) of the wear and/or damage or normalized wear and/or damage (e.g., on a scale from 0 to 3, 0 to 10, or 0 to 100).

FIG. 5 depicts a flowchart of another example method 220 for evaluating the effectiveness of a wellbore cleaning operation. Method 220 may also be thought of as a method of cleaning a downhole casing string. Digital images of selected cutting elements in a cleaning tool are acquired before deployment of the tool in a wellbore (e.g., before deployment in the drill string) at 222. The digital images may be taken from substantially any suitable vantage point, for example, normal to the face of the cutting elements and/or from the side of the cutting elements. At 224 the cleaning tool may be used to perform a cleaning or scraping operation, for example, as described above with respect to FIGS. 2 and 3. The cleaning tool may be tripped out of the wellbore and digital images of the selected cleaning elements acquired at 226. The digital images may be advantageously taken from the same vantage points (and same magnification, lighting, etc.) as those acquired prior to the cleaning operation. The digital images acquired at 222 and 226 may be evaluated and/or compared using a trained machine learning algorithm to estimate an effectiveness of the cleaning operation at 228. The trained machine learning algorithm may also make use of (or consider) a total scraping or cleaning distance of the cleaning operation as described above. The estimated effectiveness of the cleaning operation may be output to a drilling operator or other personnel at 230.

With continued reference to FIG. 5, the ML model may be configured to extract geometry, color, and/or texture related features from the digital images (particularly of the cutting features) and to compare the extracted features before and after the cleaning operation to determine a change in the geometry, color, and/or texture related features induced by the cleaning operation. Extracted geometry features may provide the best indication of wear and damage and may include the size and shape of the cutting features in the cutting elements, for example, including the area, perimeter, width, roundness, sharpness, regularity, and angularity of the cutting features. The color related features may enable cement or other residue to be identified and may include, for example, average (such as mean, median, or mode) red, green, and blue intensities or distributions of or standard deviations of red, green, and blue intensities and/or an average luminance of the cutting features. The color related features may further include a histogram, a variance, a skewness, and/or a kurtosis of the red, green, and blue intensities. The texture related features may also provide a secondary indication of wear and residue and may quantify various spatial relationships and/or directional changes in pixel color and/or brightness in the cutting features. Extracted texture related features may include, for example, edge detection, pixel to pixel contrast, correlation, and/or entropy. In addition, in certain embodiments, texture related features may be extracted with techniques such as image texture filters (e.g., Gabor filters, and so forth), an autoencoder, or other deep learning based techniques.

FIG. 6 depicts an example block diagram 250 of ML model training. The ML model is shown at 260. Historical data (images) 265 from a large number of cleaning operations are input into the ML model 260. The historical data may include digital images taken before and after the cleaning operations along with a total cleaning depth (e.g., a number of passes times the distance of each pass). The digital images may be evaluated to extract geometry, texture, and/or color related features as described above to determine changes in these features that occur during cleaning (during a cleaning operation). The historical data 265 may further include a wear or damage parameter (or label) that is indicative of the wear and/or damage of the cutting features. This wear or damage parameter (label) may be assigned by skilled personnel in the field and may include a numerical indicator of the wear and/or damage on a fixed scale (e.g., as described above on a scale from 0 to 3, 0 to 10, or 0 to 100).

With continued reference to FIG. 6, the machine learning model 260 may be configured to process the historical images 265, for example, the extracted geometry, color, and/or textural features, the wear or damage parameter, and the total cleaning depth to generate a trained model 270 that includes relationships and/or correlations between the extracted geometry, color, and/or textural features and the wear or damage parameter. The wear or damage parameter may then be correlated with the effectiveness of the cleaning operation.

FIG. 7 depicts a block diagram of an example system 300 for estimating the effectiveness of a wellbore cleaning operation. The system 300 includes a digital camera system 310 configured to take one or more calibrated digital images of a selected cutting element. The digital camera system may include substantially any suitable digital camera (or cameras) sensitive to infrared, visible, and/or ultraviolet light. The system further includes a digital image processing system 320, for example, including one or more processors or computing systems. The digital image processing system 320 may include the trained ML algorithm described above. The system 320 may include a segmenting module 322 configured to identify individual cutting features (teeth) in the digital images. The segmenting module 322 may make use of substantially any suitable digital imaging processing techniques for identifying features within a digital image. The digital image processing system 320 may further include a geometry, color, and/or texture feature extraction module 324 configured to extract geometry, color, and/or texture features (as described above) from the calibrated digital images or from selected ones of the identified cutting features in the segmented image. The digital image processing system 320 may further include a comparison module 326 that determines changes in the extracted geometry, color, and/or texture features. The digital image processing system 320 may further include a trained ML model or dataset 328 that correlates the changes in the extracted geometry, color, and/or texture features with an estimated effectiveness of the cleaning operation (e.g., based on a wear or damage parameter).

Although a wellbore cleaning tool evaluation has been described in detail, it should be understood that various changes, substitutions and alternations can be made herein without departing from the spirit and scope of the disclosure as defined by the appended claims.

1. A method for cleaning a section of a downhole casing string, the method comprising:
acquiring first digital images of selected cutting elements in a cleaning tool;
deploying the cleaning tool in a wellbore;
cleaning a section of a downhole casing string using the deployed cleaning tool;
tripping the cleaning tool out of the wellbore after the cleaning;
acquiring second digital images of the selected cutting elements after the tripping; and
estimating a measure of casing string cleaning effectiveness by evaluating the first and second digital images using a trained machine learning algorithm.

2. The method of claim 1, wherein the trained machine learning algorithm is trained using historical digital images taken before and after historical cleaning operations, a total cleaning depth for each of the historical cleaning operations; and an assigned wear or damage parameter that provides a label that is indicative of the wear or damage imparted to the selected cutting elements during the historical cleaning operations.

3. The method of claim 2, wherein the assigned wear or damage parameter is a numerical indicator of the wear and/or damage on a fixed numerical scale.

4. The method of claim 1, wherein the trained machine learning algorithm is configured to:
extract a geometry related feature of the selected cutting elements from each of the first and second digital images;
determine a change in the geometry related feature induced by the cleaning; and
correlate the change in the geometry related feature with the measure of casing string cleaning effectiveness.

5. The method of claim 4, wherein the geometry related feature is a size related feature of the selected cutting elements, and the trained machine learning algorithm is configured to:
extract the size related feature of the selected cutting elements from each of the first and second digital images;
determine a change in the size related feature induced by the cleaning; and
correlate the change in the size related feature with the measure of casing string cleaning effectiveness.

6. The method of claim 4, wherein the geometry related feature is a shape related feature of the selected cutting elements and the trained machine learning algorithm is configured to:
extract the shape related feature of the selected cutting elements from each of the first and second digital images;
determine a change in the shape related feature induced by the cleaning; and
correlate the change in the shape related feature with the measure of casing string cleaning effectiveness.

7. The method of claim 4, wherein the trained machine learning algorithm is configured to further extract a color related feature of the selected cutting elements and to determine changes in the color related feature induced by the cleaning, the color related features including at least one of average red, green, and blue intensities and distributions or standard deviations of red, green, and blue intensities.

8. The method of claim 4, wherein the trained machine learning algorithm is configured to further extract a texture related feature of the selected cutting elements and to determine changes in the texture related feature induced by the cleaning, the texture related feature including at least one of edge detection, pixel to pixel contrast, correlation, and entropy.

9. A method for estimating an effectiveness of a wellbore cleaning operation, the method comprising:
acquiring before and after digital images of selected cutting elements on a borehole cleaning tool, the before digital images acquired before a downhole cleaning operation and the after digital images acquired after the downhole cleaning operation;
comparing the before and after digital images to determine wear or damage to the selected cutting elements caused by the downhole cleaning operation; and
estimating a measure of casing string cleaning effectiveness from the determined wear or damage, wherein an increase in the determined wear or damage indicates an increase in the measure of casing string cleaning effectiveness.

10. The method of claim 9, wherein the comparing the before and after digital images further comprises determining a normalized wear or damage based on a total scraping or cleaning distance of the cleaning operation.

11. The method of claim 10, wherein the comparing the before and after digital images further comprises assigning a numerical indicator of the normalized wear or damage on a fixed numerical scale.

12. The method of claim 9, wherein the comparing and the estimating further comprises evaluating the before and after digital images using a trained machine learning algorithm to estimate the measure of casing string cleaning effectiveness.

13. The method of claim 9, wherein the trained machine learning algorithm is trained using historical digital images taken before and after historical cleaning operations, a total cleaning depth for each of the historical cleaning operations; and an assigned wear or damage parameter that provides a label that is indicative of the wear or damage imparted to the selected cutting elements during the historical cleaning operations.

14. The method of claim 9, wherein the comparing and the estimating further comprises:
comparing a size related feature of the selected cutting elements from each of the before and after digital images;
determining a change in the size related feature induced by the cleaning; and
correlating the change in the size related feature with the measure of casing string cleaning effectiveness.

15. The method of claim 9, wherein the comparing and the estimating further comprises:
comparing a shape related feature of the selected cutting elements from each of the before and after digital images;
determining a change in the shape related feature induced by the cleaning; and
correlating the change in the shape related feature with the measure of casing string cleaning effectiveness.

16. A system for estimating an effectiveness of a wellbore cleaning operation, the system comprising:
a digital camera system configured to take one or more digital images of selected cutting elements in a wellbore cleaning tool; and
a digital image processing system including a plurality of modules, the modules comprising:
a segmenting module configured to identify cutting features on the selected cutting elements in the digital images;
a feature extraction module configured to extract at least geometry related features from the identified cutting features;
a comparison module configured to determine changes in the extracted geometry features caused by the wellbore cleaning operation; and
a cleaning effectiveness module configured to correlate the determined changes in the extracted geometry features with a measure of cleaning effectiveness.

17. The system of claim 16, wherein the extracted geometry features are size related features of the identified cutting features.

18. The system of claim 16, wherein the extracted geometry features are shape related features of the identified cutting features.

19. The system of claim 16, wherein:
the feature extraction module is further configured to extract color and texture related features from the identified cutting features;
the comparison module is further configured to determine changes in the extracted color and texture related features caused by the wellbore cleaning operation; and
the cleaning effectiveness module is further configured to correlate the determined changes in the extracted geometry, color, and texture related features with the measure of cleaning effectiveness.

20. The system of claim 16, wherein the digital image processing system comprises a trained machine learning algorithm the trained machine learning algorithm being trained using historical digital images taken before and after historical cleaning operations, a total cleaning depth for each of the historical cleaning operations; and an assigned wear or damage parameter that provides a label that is indicative of the wear or damage imparted to the selected cutting elements during the historical cleaning operations.
